(19) United States
(12) Patent Application Publication
(10) Pub. No.: US 2024/0217403 A1
(43) Pub. Date: Jul. 4, 2024

(54) Head and Neck Child Car Seat Support Device

(71) Applicant: Ryan Oertel, Crystal Lake, IL (US)

(72) Inventor: Ryan Oertel, Crystal Lake, IL (US)

(21) Appl. No.: 18/398,232

(22) Filed: Dec. 28, 2023

Related U.S. Application Data
(60) Provisional application No. 63/435,569, filed on Dec. 28, 2022.

(51) Int. Cl. B60N 2/28; B60N 2/882

(52) U.S. Cl. CPC B60N 2/2851; B60N 2/882

(57) ABSTRACT

A head and neck child car seat support device is disclosed. The device is comprised of a stable body and removable, padded cushion(s) that can be used universally in collaboration with a forward-facing child car seat to promote comfort, encourage the child's head, neck, and torso to remain in an upright position and reduce the risk of injury to the head, neck, back, or torso when sitting in a front-facing child seat.

### CROSS-REFERENCE TO RELATED APPLICATION

The present application claims priority to, and the benefit of, U.S. Provisional Application No. 63/435,569, which was filed on Dec. 28, 2022, and is incorporated herein by reference in its entirety.

### FIELD OF THE INVENTION

The present invention relates generally to the field of head and neck supports. More specifically, the present invention relates to a head and neck child car seat support device that can be applied to a front-facing child's seat to provide support for the child's head, neck, and torso, which allows for elevated comfort and reduces the risk of injury to the child's head and neck. Accordingly, the present disclosure makes specific reference thereto. Nonetheless, it is to be appreciated that aspects of the present invention are also equally applicable to other like applications, devices, and methods of manufacture.

### BACKGROUND

When traveling in a vehicle, young children are placed in a car seat for their safety. As a child gets older, said child typically rides in a forward-facing car seat. In these seats, the child's head and neck are prone to tilting forward, especially if they fall asleep in the seat. This may cause significant discomfort and restrict the child's airflow. In addition, a child in a forward-facing seat, with an unrestrained head and neck, is at an elevated risk of whiplash or another injury if the vehicle moves suddenly, crashes, or comes to a sudden stop.

Therefore, there exists a long-felt need in the art for a device that provides additional security and stabilization to a child in a forward-facing child seat. More specifically, there exists a long-felt need in the art for a head and neck child car seat support device that can be applied to a forward-facing car seat to stabilize a child's head and neck and reduce discomfort and risk of injury. Furthermore, there exists a long-felt need in the art for a head and neck child car seat support device that can be applied to a forward-facing car seat to stabilize the child's head and neck to reduce discomfort and risk of injury, wherein the device can be universally applied to any forward-facing car seat.

The subject matter disclosed and claimed herein, in one embodiment thereof, comprises a head and neck child car seat support device. The device is comprised of a first torso support member and a second torso support member each comprised of a recessed area, a fastener, and at least one removable, washable cushion; at least one vertical support member with a fastener and at least one removable, washable cushion; and a head support member with a fastener and at least one removable, washable cushion. The torso support members, vertical support member, and head support member are preferably comprised of a plastic, metal, or hybrid material that provides both comfort and stability to the head and neck of the user in the event of a crash or other sudden movement of the vehicle.

In this manner, the head and neck child car seat support device of the present invention accomplishes all the foregoing objectives and provides a device that reduces discomfort and risk of injury to a child using a front-facing car seat. More specifically, the head and neck child car seat support device can be worn by a child in a forward-facing car seat to minimize discomfort in the head, neck, and torso area of the user, and to reduce the risk of whiplash or other injury to the user's head and/or neck. Furthermore, the device can be universally applied to virtually any forward-facing child car seat.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a head and neck child car seat support device comprised of at least one torso support member, at least one vertical support member, at least one head support member, and at least one washable, removable cushion. The device is designed to provide additional stability and security to the head and neck area of a child sitting in a forward-facing child car seat.

The device is preferably comprised of a first torso support member, a second torso support member, at least one vertical support member, and at least one head support member. Each member is preferably made from a rigid material such as, but not limited to, metal, plastic, rubber, etc., that provides the desired combination of stability and comfort. Each torso support member is also comprised of a recessed area that receives the restraints of a child car seat. As a result, the child restraints secure the device into optimal position on the child and provide additional stabilization and support to the child in the forward-facing child car seat.

The device should include at least one removable, washable cushion comprised of at least one fastener. The cushion is preferably made from a washable material such as foam, fabric, sponge, gel, or a hybrid material which provides cushion to the user of the seat and aligns with the shape of the support members.

During use, the device is placed on a child in a forward-facing child car seat, wherein the child's head is supported by placing the child's head inside the head support member. The child's neck is supported by the vertical support member, and the child's chest and torso are supported by the torso support members.

The present invention is also comprised of a method of using the device. First, a device is comprised of at least one torso support member, at least one vertical support member, at least one head support member, and at least one cushion. Then, the device is placed over the child's head and torso, wherein the vertical support member aligns with the back of the child's neck, the head support member surrounds the child's head, and the torso support members are positioned over the child's shoulders and in front of their chest. Lastly, the child seat restraints are placed into the recessed areas on the torso support members and fastened into their respective areas of the child car seat, securing the device into place.

Accordingly, the head and neck child car seat support device of the present invention is particularly advantageous as it provides a device that reduces the risk of discomfort and injury to a child using a forward-facing child car seat. More specifically, the head and neck child car seat support device can be applied to a forward-facing car seat to create a more comfortable experience for the child, minimizing discomfort in the head, neck, and torso area, and reducing the risk of whiplash or another injury to the user's head and/or neck. Furthermore, the device can be universally applied to any forward-facing child seat. In this manner, the head and neck child car seat support device provides a novel solution to head and neck injury prevention for a comfortable car-ride experience for children in front-facing car seats.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a head and neck child car seat support device of the present invention in accordance with the disclosed architecture;

FIG. 2 illustrates a side perspective view of one potential embodiment of a head and neck child car seat support device of the present invention in accordance with the disclosed architecture;

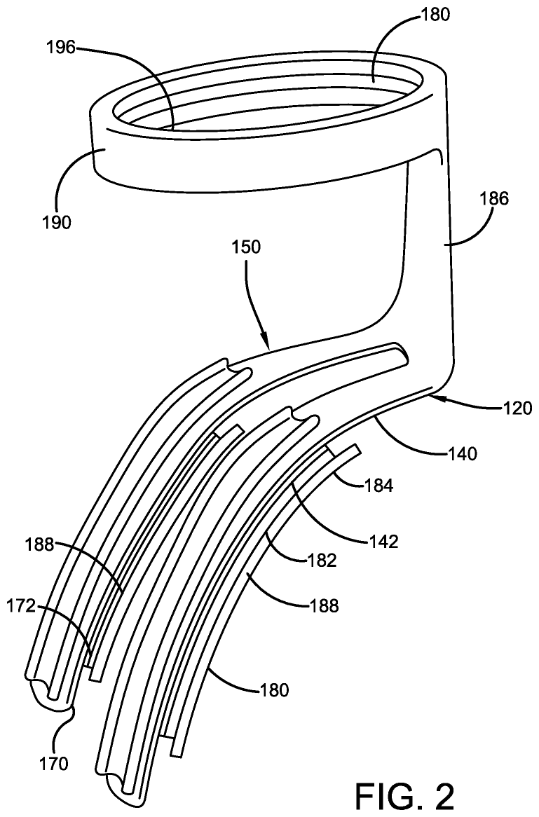

FIG. 3 illustrates a perspective view of one potential embodiment of a head and neck child car seat support device of the present invention while being worn by a child in a car seat in accordance with the disclosed architecture; and

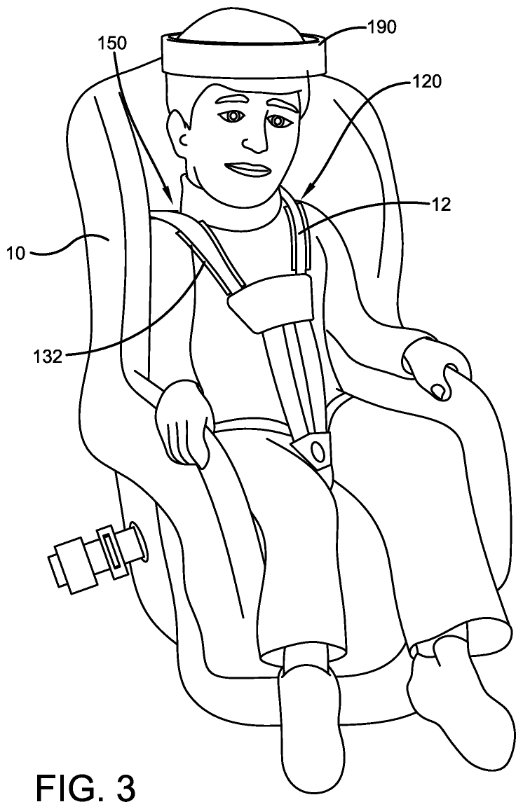

FIG. 4 illustrates a flowchart of a method of using one potential embodiment of a head and neck child car seat support device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that provides additional security and stabilization to the user of a forward-facing child seat. More specifically, there exists a long-felt need in the art for a head and neck child car seat support device that can be applied to a forward-facing car seat to stabilize the child's head and neck and reduce discomfort and risk of injury. Furthermore, there exists a long-felt need in the art for a head and neck child car seat support device that can be applied to a forward-facing car seat to stabilize the child's head and neck to reduce discomfort and risk of injury, wherein the device can be universally applied to any forward-facing car seat.

The present invention, in one exemplary embodiment, is comprised of a head and neck child car seat support device. The device is comprised of at least one torso support member, at least one vertical support member, at least one head support member, and at least one washable, removable cushion. The device is designed to be used on a child within a forward-facing child car seat with the purpose of providing additional support and stability to the child.

More specifically, the device is preferably comprised of a first torso support member, a second torso support member, at least one vertical support member, and at least one head support member. Each torso support member is comprised of an exterior surface with at least one recessed area that receives the restraints of the child car seat. The device is also comprised of a removable, washable cushion which serves the purpose of providing additional padding and comfort to the user while the device is worn.

During use, the device is placed onto a child in a forward-facing child car seat, wherein each support member aligns with its respective support area on the child (i.e., the head, neck, and torso area). Then, the restraints on the child seat are placed over the device, fitting into the recessed areas on the surface of the torso support members and fastened into their respective spaces in the child car seat securing the device into its ideal place on the child and within the domain of the car seat.

The present invention is also comprised of a method of using the device. First, a device is comprised of at least one torso support member, at least one vertical support member, at least one head support member, and at least one cushion. Then, the device is positioned onto a child in a child's car seat, wherein the support members align with the child's head, neck, and torso areas. More specifically, the head support member should surround the child's head, the vertical support member should align with the back of the child's neck, and the torso support members should fit over the child's shoulders and chest. Then, the child seat restraints are placed into the recessed areas on the torso support members and fastened into their respective areas of the child car seat, securing the device into optimal position.

Accordingly, the head and neck child car seat support device of the present invention is particularly advantageous as it provides a device that improves upon the comfort of traditional forward-facing child car seats and reduces the risk of injury to the user's head, neck, and back. More specifically, the head and neck child car seat support device can be applied to a front-facing car seat to reduce discomfort for the child and to stabilize them against sudden or exaggerated motions which might otherwise cause injury or discomfort to the head, neck, back, or torso. Furthermore, the device can be universally applied to any front-facing child seat. In this manner, the head and neck child car seat support device provides a universal solution to discomfort and risk of injury to users of forward-facing child car seats.

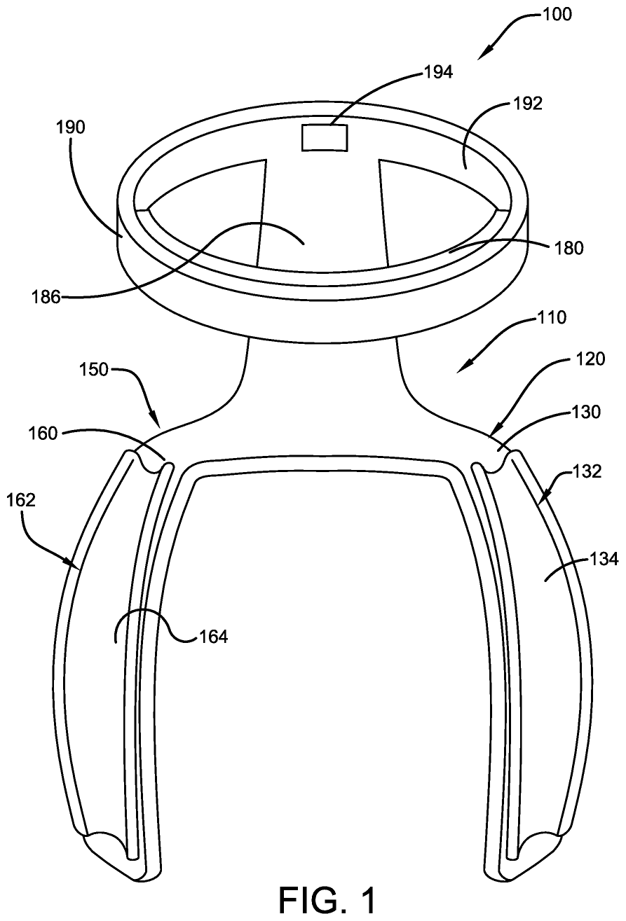

Referring initially to the drawings, FIG. 1 illustrates a perspective view of a body 110, first torso support member 120, second torso support member 150, vertical support member 186, and head support member 190 of one potential embodiment of a head and neck child car seat support device 100 of the present invention in accordance with the disclosed architecture.

The body 110 is comprised of a first torso support member 120, a second torso support member 150, a vertical support member 186, and a head support member 190. The body 110 and all elements are preferably made from a plastic, metal, hard rubber, or hybrid material that provides stability and comfort to the user of the device 100.

The first torso support member 120 is comprised of a top surface 130 which includes at least one recessed area 134. The recessed area 134 is comprised of at least one grip area 132. The grip area 132 is preferably made from a silicone, rubber, adhesive, or similar material to which prevents or reduces movement of the restraint 12 of the child seat 10 within the grip area 132. The first torso support member 120 is also comprised of a bottom surface 140. At least one fastener 142 is positioned on the bottom surface 140. The fastener 142 may be any fastener type known in the art such as, but not limited to, hook-and-loop, button, snap, tie, adhesive, magnet, or similar fastening mechanism. In one embodiment, the first torso support member 120 mirrors the shape of the right shoulder and chest area (i.e., curved) of the user of the device 100 for optimal fit, comfort, and support.

The second torso support member 150 is comprised of a top surface 160 which is comprised of at least one recessed area 164. The recessed area 164 is comprised of at least one grip area 162. The grip area 162 is preferably made from a silicone, rubber, adhesive, or similar material which prevents or reduces movement of the restraint 12 of the child seat 10 within the grip area 162. The second torso support member 150 is also comprised of a bottom surface 170, to which a fastener 172 is affixed. The fastener 172 may be any type known in the art such as, but not limited to, hook-and-loop, button, snap, tie, adhesive, magnet, or similar fastening mechanism. In one embodiment, the second torso support member 150 of the device 100 should mirror the shape of the left shoulder and chest area of the user (i.e., curved) for optimal fit, comfort, and support.

The body 110 of the device 100 is also comprised of a vertical support member 186 and a head support member 190. The head support member 190 is comprised of an opening 196 through which the child's head can enter and be surrounded by the support member 190. The head support member 190 is also comprised of an inside surface 192 onto which a fastener 194 is affixed. The fastener 194 may be any type known in the art such as, but not limited to, hook-and-loop, button, snap, tie, adhesive, magnet, or similar fastening mechanism.

The device 100 is also comprised of at least one removable, washable cushion 180. The cushion 180 is preferably made from a waterproof and/or washable fabric and filled with an impact-softening material such as foam, fabric, sponge, gel, or a similar hybrid material that provides padding to the user. The top surface 182 and/or bottom surface 184 of the cushion 180 may be comprised of at least one fastener 188. The fastener 188 may be any type known in the art but is preferably a reciprocating fastener with the fasteners 142, 172, 194 of the body 110 to allow the cushion 180 to attach to the body. In doing so, the cushion provides padding and additional comfort during use.

In one embodiment, the device 100 may be integrally formed/manufactured into a child car seat 10.

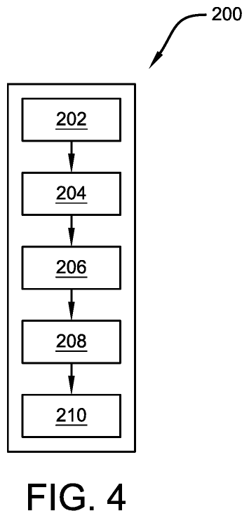

The present invention is also comprised of a method of using 200 the device 100, as seen in FIG. 4. First, a device 100 is provided primarily comprised of a body 110 comprised of a first torso support member 120 comprised of at least one recessed area 134 and at least one fastener; a second torso support member 150 comprised of at least one recessed area 164 and at least one fastener 172; a head support member 190 comprised of an opening 196; and at least one vertical support member 186 that connects the head support member 190 to the torso support members 120, 150 [Step 202]. Then, the device 100 is placed over the head of a child in a forward-facing child car seat 10 before the restraints 12 are secured over the child [Step 204]. When the device 100 is placed over the child's head, the head support member 190 should surround the head of the child, encouraging the child's head and neck to remain in an upright position while sitting in the forward-facing child car seat 10. Furthermore, the vertical support member 186 should be aligned with the back of the child's neck, while the first torso support member 120 should align with the child's right shoulder and chest area, and the second torso support member 150 should align with the child's left shoulder and chest area [Step 206]. The restraints 12 are then placed over the child and the device 100, fitting into the recessed areas 134, 164 in the first torso support member 120 and the second torso support member 150, and then are secured into the forward-facing child car seat 10 [Step 208]. Optionally, the method 200 may be comprised of the attaching at least one cushion 180 to at least one fastener 142, 172, 188 of the body [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “head and neck child car seat support device” and “device” are interchangeable and refer to the head and neck child car seat support device 100 of the present invention.

Notwithstanding the foregoing, the head and neck child car seat support device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the head and neck child car seat support device 100 as shown in the FIGS. are for illustrative purposes only, and that many other sizes and shapes of the head and neck child car seat support device 100 are well within the scope of the present disclosure. Although the dimensions of the head and neck child car seat support device 100 are important design parameters for user convenience, the head and neck child car seat support device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A head and neck child car seat support device comprising:
a first torso support member;
a second torso support member;
a head support member comprised of an opening; and
a vertical support member attached to the head support member, the first torso support member, and the second torso support member.

2. The head and neck child car seat support device of claim 1, wherein the first torso support member is curved.

3. The head and neck child car seat support device of claim 1, wherein the first torso support member is curved.

4. A head and neck child car seat support device comprising:
a first torso support member comprised of a first fastener;
a second torso support member comprised of a second fastener;
a head support member comprised of an opening and a third fastener;
a vertical support member attached to the head support member, the first torso support member, and the second torso support member; and
a cushion comprised of a fourth fastener.

5. The head and neck child car seat support device of claim 4, wherein the cushion is comprised of a washable cushion.

6. The head and neck child car seat support device of claim 4, wherein the cushion is comprised of a foam, a fabric, a sponge, or a gel material.

7. The head and neck child car seat support device of claim 4, wherein the first fastener and the fourth fastener are comprised of a pair of reciprocating fasteners.

8. The head and neck child car seat support device of claim 7, wherein the first fastener and the fourth fastener are comprised of a hook and loop fastener, a button fastener, a snap fastener, a tie fastener, an adhesive fastener, or a magnet fastener.

9. The head and neck child car seat support device of claim 4, wherein the second fastener and the fourth fastener are comprised of a pair of reciprocating fasteners.

10. The head and neck child car seat support device of claim 9, wherein the second fastener and the fourth fastener are comprised of a hook and loop fastener, a button fastener, a snap fastener, a tie fastener, an adhesive fastener, or a magnet fastener.

11. The head and neck child car seat support device of claim 4, wherein the third fastener and the fourth fastener are comprised of a pair of reciprocating fasteners.

12. The head and neck child car seat support device of claim 11, wherein the third fastener and the fourth fastener are comprised of a hook and loop fastener, a button fastener, a snap fastener, a tie fastener, an adhesive fastener, or a magnet fastener.

13. The head and neck child car seat support device of claim 4, wherein the third fastener is positioned on an inside surface of the head support member.

14. The head and neck child car seat support device of claim 4, wherein the first fastener is positioned on a first bottom surface of the first torso support member.

15. The head and neck child car seat support device of claim 4, wherein the second fastener is positioned on a second bottom surface of the second torso support member.

16. A method of using a head and neck child car seat support device, the method comprising the following steps:
providing a head and neck child car seat support device comprised of a body comprised of a first torso support member comprised of a first recessed area, a second torso support member comprised of a second recessed area, a head support member comprised of an opening, and a vertical support member connected to the head support member, the first torso member, and the second torso member;
placing the head and neck child car seat support device over a head of a child in a front-facing child car seat;
aligning the head and neck child car seat support device with the head, neck, and torso of the child; and
placing a restraint of the front-facing child car seat into a recessed area on the first torso support member or second torso support member and securing the restraint into the front-facing child car seat.

17. The method of claim 16, wherein the first torso support is comprised of a first fastener.

18. The method of claim 16, wherein the second torso support is comprised of a second fastener.

19. The method of claim 16, wherein the head support is comprised of a third fastener.

20. The method of claim 19, wherein the head and neck child car seat support device is comprised of a cushion comprised of a fourth fastener.
